(19) United States
(12) Patent Application Publication
(10) Pub. No.: US 2015/0362873 A1
(43) Pub. Date: Dec. 17, 2015

(54) Fixing Device, Image Forming Apparatus

(71) Applicant: KYOCERA DOCUMENT SOLUTIONS INC., Osaka-shi, Osaka (JP)

(72) Inventor: Mariko Fukami, Osaka-shi (JP)

(21) Appl. No.: 14/434,078

(22) PCT Filed: Oct. 7, 2014
(86) PCT No.: PCT/JP2014/076745

§ 371 Date: Apr. 7, 2015

(30) Foreign Application Priority Data
Dec. 17, 2013 (JP) 2013-260265

(51) Int. Cl. G03G 15/20

(52) U.S. Cl. CPC G03G 15/2025

(57) ABSTRACT

A fixing device that can suppress UFP generation includes a heating roller, a heater, and a dust preventing member. The heating roller is larger in width than a maximum paper passing region through which a sheet of a predetermined maximum size passes. The heater heats the heating roller. The dust preventing member is provided in an inner layer part of the heating roller between a paper non-passing region and a rotation shaft of the heating roller, the paper non-passing region being located outside the maximum paper passing region in an axis direction of the rotation shaft. The dust preventing member is made of a material from which UFPs are not generated or are difficult to be generated in a temperature environment in which the dust preventing member is heated and can reach a predetermined temperature at most.

### TECHNICAL FIELD

The present invention relates to a fixing device for fixing toner on a sheet, and to an image forming apparatus including the fixing device.

### BACKGROUND ART

An electrophotographic image forming apparatus includes a fixing device by which toner that has adhered to a sheet is fixed to the sheet. The fixing device includes a heating roller and a pressure roller. The heating roller is heated to a predetermined fixing temperature. The pressure roller is configured to be rotatable while being in pressure-contact with the heating roller. The toner that has adhered to the sheet is fused and fixed to the sheet when the sheet passes through a nip portion between the heating roller and the pressure roller.

Meanwhile, in recent years, it is desirable that the fixing devices be able to prevent generation of not only VOC (Volatile Organic Compound) but also UFP (Ultra Fine Particle). For example, it has been found that UFPs are generated when a silicon-based material used in the heating roller and the pressure roller of the fixing device is heated. With regard to this, there are known a configuration for sucking and removing UFPs generated in the fixing device (see Patent Literature 1), and a configuration for suppressing VOCs from being generated from silicon-based materials (see Patent Literature 2).

### CITATION LIST

### Patent Literature

[PTL 1] Japanese Laid-Open Patent Publication No. 2012-47790
[PTL 2] Japanese Laid-Open Patent Publication No. 2008-9264

### SUMMARY OF THE INVENTION

### Problems to be Solved by the Invention

However, providing a configuration for sucking and removing UFPs generated in the fixing device will increase the size and cost of the fixing device and the image forming apparatus.

It is an object of the present invention to provide a fixing device and an image forming apparatus that can suppress the UFP generation amount by a simple configuration.

### Solution to the Problems

A fixing device according to one aspect of the present invention includes a roller member, a heater, and a dust preventing member. The roller member is larger in width than a maximum paper passing region through which a sheet of a predetermined maximum size passes. The heater is configured to heat the roller member. The dust preventing member is provided in an inner layer part of the roller member between a paper non-passing region and a rotation shaft of the roller member, and made of a material from which ultra fine particles are not generated or are difficult to be generated in a temperature environment in which the dust preventing member is heated by heat transmitted from the heater and can reach a predetermined temperature at most, the paper non-passing region being located outside the maximum paper passing region in an axis direction of the rotation shaft.

An image forming apparatus according to another aspect of the present invention includes a fixing device. The fixing device includes a roller member, a heater, and a dust preventing member. The roller member is larger in width than a maximum paper passing region through which a sheet of a predetermined maximum size passes. The heater is configured to heat the roller member. The dust preventing member is provided in an inner layer part of the roller member between a paper non-passing region and a rotation shaft of the roller member, and made of a material from which ultra fine particles are not generated or are difficult to be generated in a temperature environment in which the dust preventing member is heated by heat transmitted from the heater and can reach a predetermined temperature at most, the paper non-passing region being located outside the maximum paper passing region in an axis direction of the rotation shaft.

### Advantageous Effects of the Invention

According to the present invention, it is possible to realize a fixing device and an image forming apparatus that can suppress the UFP generation amount by a simple configuration.

### BRIEF DESCRIPTION OF THE DRAWINGS

FIG. 1 is a diagram showing the configuration of an image forming apparatus according to an embodiment of the present invention.

FIG. 2 is a diagram showing the configuration of a fixing device according to an embodiment of the present invention.

FIG. 3 is a diagram showing the internal configuration of a heating roller and a pressure roller in the fixing device.

FIG. 4A is a diagram showing another example of the pressure roller.

FIG. 4B is a diagram showing a still another example of the pressure roller.

FIG. 4C is a diagram showing a further example of the pressure roller.

FIG. 4D is a diagram showing a still further example of the pressure roller.

FIG. 5A is a diagram showing a comparative example of the pressure roller.

FIG. 5B is a diagram showing a comparative example of the pressure roller.

FIG. 6 is a diagram showing the temperature distribution in a maximum paper passing region and paper non-passing regions of the pressure roller in the fixing device according to an embodiment of the present invention.

FIG. 7 is a diagram showing an example of the relationship between the temperature of the pressure roller and the UFP generation amount in the fixing device according to an embodiment of the present invention.

### DESCRIPTION OF EMBODIMENTS

The following describes an embodiment of the present disclosure with reference to the accompanying drawings for the understanding of the invention. It should be noted that the following description is an example of a specific embodiment of the present invention and should not limit the technical scope of the invention.

[Outlined Configuration of Image Forming Apparatus 10]

First, an outlined configuration of an image forming apparatus 10 according to an embodiment of the present invention is described.

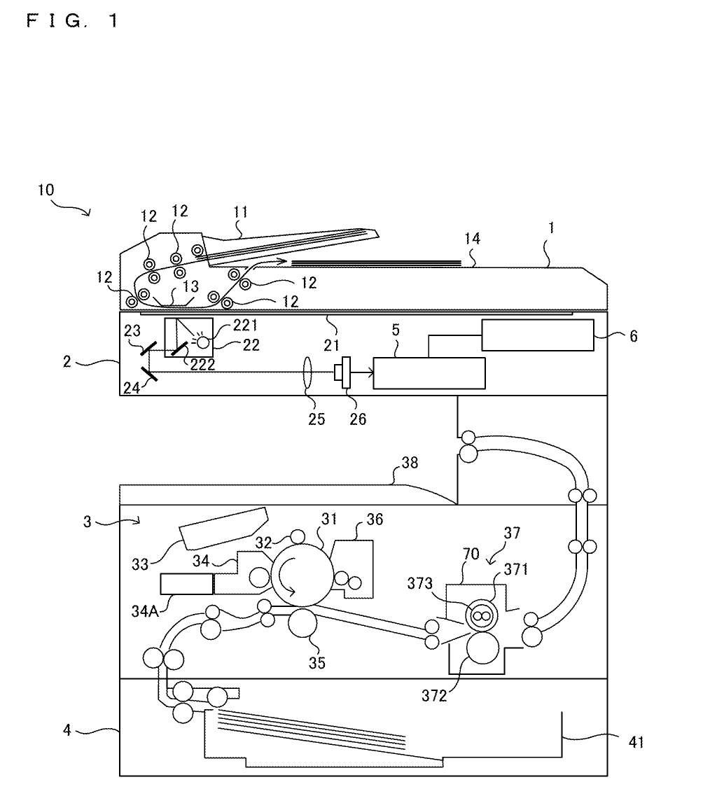

As shown in FIG. 1, the image forming apparatus 10 includes an ADF 1, an image reading portion 2, an image forming portion 3, a sheet feed portion 4, a control portion 5, a display input device 6, and the like. The image forming apparatus 10 is a multifunction peripheral having a plurality of functions such as a print function, a facsimile function, a scan function, and a copy function. It is noted that the present invention is also applicable to such an image forming apparatus as a printer, a facsimile, or a copier.

The ADF 1 is an automatic document sheet feeding device and includes a document sheet setting portion 11, a plurality of conveying rollers 12, a document sheet pressing 13, and a sheet discharge portion 14. In the ADF 1, the plurality of conveying rollers 12 are driven by motors (not shown) such that the document sheet placed on the document sheet setting portion 11 is conveyed in such a way as to pass through an image data reading position under the document sheet pressing 13 where the image data is read by the image reading portion 2, and then conveyed to the sheet discharge portion 14. With this configuration, the image reading portion 2 can read image data from the document sheet conveyed by the ADF 1.

The image reading portion 2 includes a document sheet table 21, a reading unit 22, a mirror 23, a mirror 24, an optical lens 25, and a CCD (Charge Coupled Device) 26. The document sheet table 21 is a document sheet mounting portion provided on the upper surface of the image reading portion 2. The reading unit 22 includes an LED light source 221 and a mirror 222. The LED light source 221 includes a number of white LEDs arranged along a main scanning direction (the depth direction in FIG. 1). The mirror 222 reflects, toward the mirror 23, light which was irradiated from the LED light source 221 and reflected on the surface of the document sheet at the reading position on the document sheet table 21. The reading unit 22 is movable in a sub scanning direction (the left-right direction in FIG. 1). The light reflected on the mirror 222 is guided into the optical lens 25 by the mirrors 23 and 24. The optical lens 25 condenses incident light and makes the condensed light incident on the CCD 26. The CCD 26 includes a photoelectric converting element and the like, wherein the photoelectric converting element inputs an electric signal that corresponds to the amount of light incident from the optical lens 25, to the control portion 5 as image data of the document sheet.

The image forming portion 3 is an electrophotographic image forming portion that executes an image forming process (print process) based on image data read by the image reading portion 2, or image data input from an external information processing apparatus such as a personal computer. Specifically, the image forming portion 3 includes a photoconductor drum 31, a charging device 32, an exposure device 33, a developing device 34, a transfer roller 35, a cleaning device 36, a fixing device 37, and a sheet discharge tray 38. In the image forming portion 3, an image is formed in the following procedure on a sheet supplied from a sheet feed cassette 41 that is attachable and detachable with respect to the sheet feed portion 4. The sheet with the image formed thereon is discharged onto the sheet discharge tray 38. It is noted that the sheet is a sheet-like material such as a sheet of paper, a sheet of coated paper, a postcard, an envelope, or an OHP sheet.

First, the charging device 32 charges the surface of the photoconductor drum 31 uniformly to a certain potential. Next, the optical scanning device 33 irradiates the surface of the photoconductor drum 31 with light based on the image data. With this operation, an electrostatic latent image corresponding to the image data is formed on the surface of the photoconductor drum 31. Then the electrostatic latent image on the photoconductor drum 31 is developed (visualized) as a toner image by the developing device 34. It is noted that the toner (developer) is supplied to the developing device 34 from a toner container 34A that is attachable and detachable with respect to the image forming portion 3. Subsequently, the toner image formed on the photoconductor drum 31 is transferred to a sheet by the transfer roller 35. The toner image transferred to the sheet is then heated by the fixing device 37 to be fused and fixed to the sheet. It is noted that the toner that has remained on the surface of the photoconductor drum 31 is removed by the cleaning device 36.

The control portion 5 includes CPU, ROM, and RAM. The CPU is a processor for executing various types of arithmetic processes. The ROM is a nonvolatile storage portion in which various types of information such as control programs for causing the CPU to execute various types of processes are stored in advance. The RAM is a volatile storage portion, and is used as a temporary storage memory (working area) for the various types of processes executed by the CPU. It is noted that the control portion 5 may be formed as an electric circuit such as ASIC or DSP.

[Configuration of Fixing Device 37]

Next, a detailed configuration of the fixing device 37 is described.

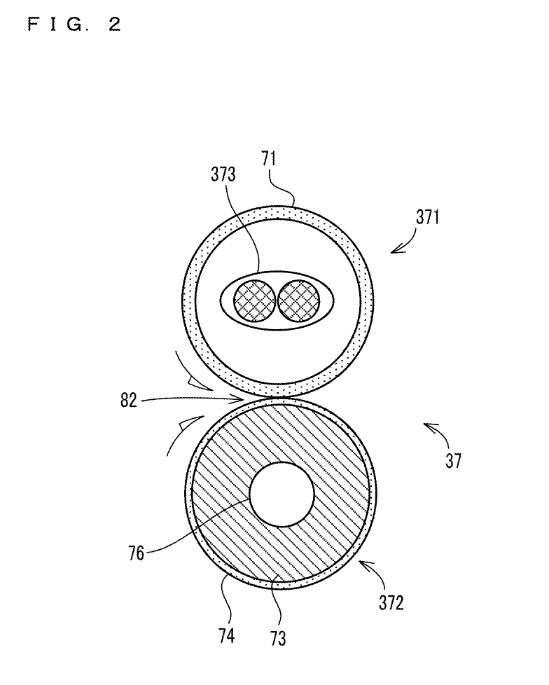

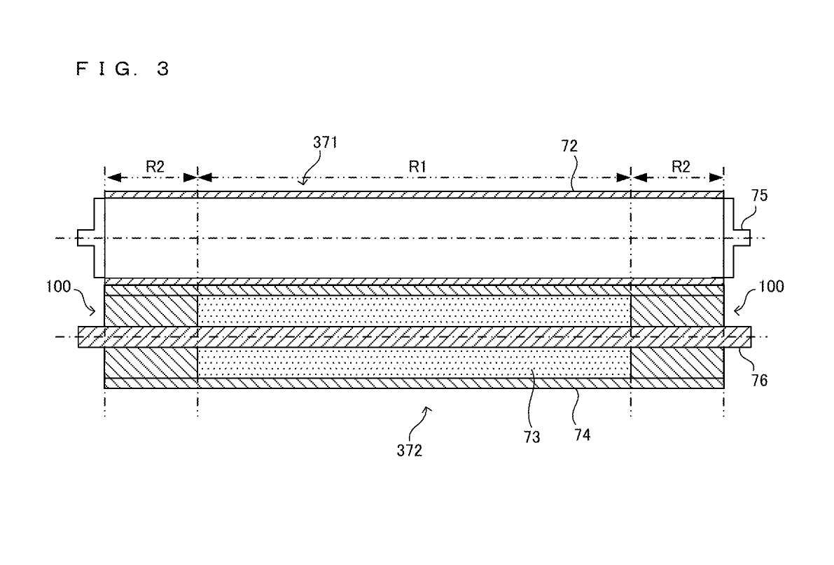

As shown in FIG. 2, the fixing device 37 includes a heating roller 371 and a pressure roller 372 that are rotatably supported by a housing 70 (see FIG. 1) of the fixing device 37. With regard to the heating roller 371, rotation shafts 75 (see FIG. 3) that are provided at opposite ends thereof in the longitudinal direction are rotatably supported by the housing 70. With regard to the pressure roller 372, a rotation shaft 76 (see FIG. 3) that is provided at the center thereof is rotatably supported by the housing 70. The rotation shafts 75 and 76 are all made of aluminum. The heating roller 371 includes, inside thereof, a heater 373. The heating roller 371 is heated by the heater 373 to a predetermined fixing temperature. In the present embodiment, the fixing temperature is set to 200° C. It is noted that the pressure roller 372 is an example of the roller member of the present invention.

The outer circumferential surface of the heating roller 371 is coated with a fluorine coating layer 71 that is made of fluororesin such as PFA or PTFE. The fluorine coating layer 71 is formed on the surface of the heating roller 371 by a method of applying a fluororesin-based coating material by spraying, or a dipping method of dipping the heating roller 371 into a molten fluororesin to be coated therewith, or other method. The fluorine coating layer 71 is in an approximate thickness range of several μm to several mm, and is 1.0 mm thick in the present embodiment. Since the heating roller 371 is coated with the fluorine coating layer 71, the toner on the sheet is fixed to the sheet without adhering to the heating roller 371. In addition, a coating material that contains a metal oxide is applied to the inner circumferential surface of the heating roller 371 by an adhesive that contains modified silicon. This allows the heat provided by the heater 373 to be efficiently absorbed by the heating roller 371. It is noted that the diameter of the heating roller 371 is, for example, 20 mm.

The material of the pressure roller 372 includes an elastic member 73 and a fluorine coating layer 74, wherein the elastic member 73 is made of elastic silicon rubber, and the fluorine coating layer 74 is made of fluororesin. Specifically, the elastic member 73 constitutes the inner layer of the pressure roller 372. In addition, the fluorine coating layer 74 (an example of the separation layer portion of the present invention) is formed as the surface layer of the pressure roller 372. The elastic member 73 is provided around the circumferential surface of the rotation shaft 76. The pressure roller 372 is configured such that a through hole is formed to pass through the center of the elastic member 73 that has been formed in a cylindrical shape, and the rotation shaft 76 is inserted into the through hole. The fluorine coating layer 74 is formed on the surface of the pressure roller 372 by a method of applying a fluororesin-based coating material by spraying, or a dipping method of dipping the pressure roller 372 into a molten fluororesin to be coated therewith, or other method. The fluorine coating layer 74 is in an approximate thickness range of several μm to several mm, and is 1 mm thick in the present embodiment. Since the pressure roller 372 is coated with the fluorine coating layer 74, the sheet is difficult to adhere to the pressure roller 372, the sheet separation performance during the fixing is increased, and an excellent sheet separation is ensured. It is noted that the diameter of the pressure roller 372 is, for example, 20 mm.

The pressure roller 372 is biased toward the pressure roller 372 by a biasing mechanism (not shown), and is rotatable while being in pressure-contact with the heating roller 371. This allows a nip area 82 to be formed between the heating roller 371 and the pressure roller 372. As a result, when the heating roller 371 is heated by the heater 373, heat is transmitted from the heating roller 371 to the pressure roller 372 via the nip area 82, and the pressure roller 372 is heated. That is, the pressure roller 372 is indirectly heated via the heating roller 371 in the state where the pressure roller 372 is in pressure-contact with the heating roller 371 that is being heated by the heater 373. When a sheet with a toner image transferred thereon passes through the nip area 82 between the heating roller 371 and the pressure roller 372, the toner image receives heat and is fused and fixed to the sheet.

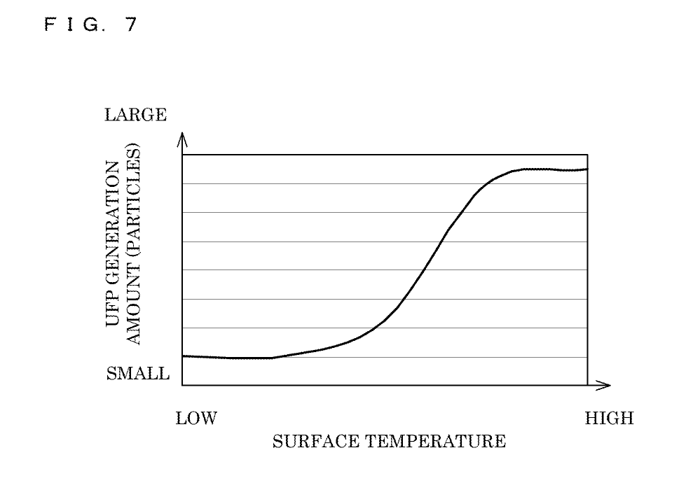

Meanwhile, when the pressure roller 372 is heated via the heating roller 371 heated by the heater 373 and reaches a predetermined temperature or higher, particles of siloxane component may evapolate as UFPs from the pressure roller 372. Specifically, when silicon rubber used as the material of the pressure roller 372 is heated to the predetermined temperature or higher, particles of siloxane component evapolate as UFPs from the silicon rubber. As shown in FIG. 7, it is known, as the relationship between the surface temperature of the pressure roller 372 and the UFP generation amount, that the UFP generation amount is small when the surface temperature is low, and the UFP generation amount drastically increases when the surface temperature exceeds a predetermined temperature.

In recent years, it has been found that the UFP is a causative material of health hazard and environmental pollution, and thus the need for suppressing generation of UFPs is high. As a method for removing the generated UFPs, a configuration for sucking and removing UFPs generated in the fixing device 37 may be considered. However, the configuration will increase the size and cost of the fixing device 37 and the image forming apparatus 10. As a result, in the present embodiment, the fixing device 37 adopts a configuration for preventing generation of UFPs themselves, as described in the following.

Here, FIG. 3 is a cross section taken along a line connecting centers of the rotation shafts 75 and 76 of the heating roller 371 and the pressure roller 372. It is noted that in FIG. 3, the heater 373 is omitted for the sake of explanation.

As shown in FIG. 3, the heating roller 371 and the pressure roller 372 are larger in width than a maximum paper passing region R1 through which a sheet of a predetermined maximum printable size in the image forming apparatus 10 passes. Regions outside the maximum paper passing region R1 in the heating roller 371 and the pressure roller 372 in the axis direction of the rotation shafts 75 and 76 are paper non-passing regions R2 through which sheets do not pass.

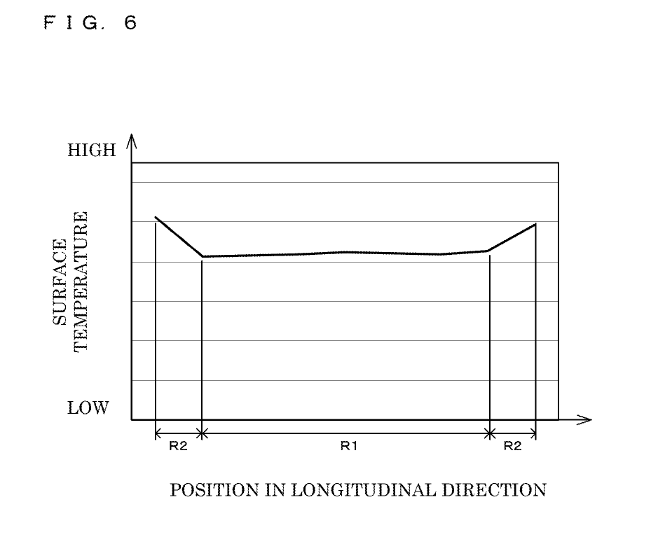

Since no sheet passes through the paper non-passing regions R2, the temperature in the paper non-passing regions R2 becomes higher than in the maximum paper passing region R1 when, for example, a continuous printing is performed (see FIG. 6). Specifically, the surface temperature of the pressure roller 372 may be approximately 30° C. higher in the paper non-passing regions R2 than in the maximum paper passing region R1. That is, in the pressure roller 372, UFPs tend to be generated in the paper non-passing regions R2. In particular, when the heating roller 371 and the pressure roller 372 with small diameters are used to realize the size reduction and high-speed printing, UFPs tend to be generated from the pressure roller 372 in the paper non-passing regions R2.

In view of this problem, in the present embodiment, the pressure roller 372 is provided with dust preventing members 100 (see FIG. 3) that are configured to prevent generation of UFPs in the paper non-passing regions R2. As shown in FIG. 3, the dust preventing members 100 are provided in inner layer parts of the pressure roller 372 between the paper non-passing regions R2 and the rotation shaft 76, wherein the paper non-passing regions R2 are located outside the maximum paper passing region R1 in the axis direction of the rotation shaft 76. It is noted that the elastic member 73 made of silicon rubber is provided in an inner layer part of the pressure roller 372 between the maximum paper passing region R1 and the rotation shaft 76. In the present embodiment, as described below, the dust preventing members 100 are made of a material from which UFPs are not generated or are difficult to be generated in a temperature environment in which the dust preventing members 100 are heated by the heat transmitted from the heater 373 and can reach the predetermined temperature at most.

The material of the dust preventing members 100 was specified as follows. Specifically, FMPS (Fast Mobility Particle Sizer) Model 3091 made by TSI Incorporated was used to measure the UFP generation amount. Test pieces TP1 to TP4 were prepared, wherein the test piece TP1 was made of silicon-based resin, the test piece TP2 was made of fluororesin (PTFE resin), the test piece TP3 was made of polyimide-based resin (PAI resin), and the test piece TP4 was made of aluminum (predetermined metal). Each test piece was stored in a case and heated to 300° C. individually. The UFP generation amount of each test piece was measured by using the FMPS. The measurement results are shown in Table 1.

TABLE 1

| | |
|---|---|
| Temperature | Test piece [particles/cm³] |

| (° C.) | TP1 | TP2 | TP3 | TP4 |
|---|---|---|---|---|
| 150 | 0 | 0 | 0 | 0 |
| 200 | 8000 | 2000 | 100 | 200 |
| 230 | 50000 | 8000 | 2000 | 500 |
| 250 | 380000 | 50000 | 6000 | 800 |
| 300 | 1000000 | 400000 | 60000 | 500 |

As described above, the fixing temperature in the fixing device 37 is set to 200° C. It was assumed that the temperature in the paper non-passing regions R2 might become higher than the fixing temperature in the maximum paper passing region R1 by approximately 30° C. As a result, in the present embodiment, the material of the dust preventing members 100 was specified based on the number of UFPs generated at 230° C. Specifically, a material from which 1.0×10⁴ UFPs/cm³ or less were generated at 230° C. was specified as a material from which UFPs are not generated or are difficult to be generated in a temperature environment of 230° C. or lower. That is, as will be understood from the measurement results shown in Table 1, fluororesin which is the material of the test piece TP2, polyimide-based resin which is the material of the test piece TP3, and aluminum which is the material of the test piece TP4 were specified as possible materials of the dust preventing members 100. In other words, the dust preventing members 100 are made of fluororesin, polyimide-based resin, or aluminum. These materials for the dust preventing members 100 are evaluated as materials from which UFPs are not generated or are difficult to be generated even if they are heated to 230° C.

The dust preventing members 100 are made of any of the above-described materials and are provided in the inner layer parts of the pressure roller 372 between the paper non-passing regions R2 and the rotation shaft 76. As a result, even when a continuous printing is performed and the temperature in the paper non-passing regions R2 increases to 230° C. that is higher than the fixing temperature 200° C., UFPs are not generated from the vicinities of the paper non-passing regions R2. Here, if UFPs are generated, the UFP generation amount would be very small. With this structure, it is possible to suppress the UFP generation amount with a simpler configuration than the configuration for sucking and removing generated UFPs, and without increase in size of the apparatus.

### EXAMPLES

The following describes configurations of pressure rollers 372A to 372D to which the dust preventing members 100 have been applied, and configurations of pressure rollers 372E and 372F to which the dust preventing members 100 have not been applied. Table 2 shows measurement results of UFP generation amount in each image forming apparatus 10 with the fixing device 37 having a different one among these pressure rollers. It is noted that a multifunction peripheral TASKalfa 256i made by KYOCERA Document Solutions Inc. was used as the image forming apparatus 10. In Table 2, Example 1 is the image forming apparatus 10 having the pressure roller 372A, Example 2 is the image forming apparatus 10 having the pressure roller 372B, Example 3 is the image forming apparatus 10 having the pressure roller 372C, and Example 4 is the image forming apparatus 10 having the pressure roller 372D. In addition, Comparative example 1 is the image forming apparatus 10 having the pressure roller 372E, and Comparative example 2 is the image forming apparatus 10 having the pressure roller 372F.

TABLE 2

| | Example | Example | Example | Example | Comparative | Comparative |
|---|---|---|---|---|---|---|
| | 1 | 2 | 3 | 4 | example 1 | example 2 |
| Dust | Fluorine- | PAI- | Metal- | Metal- | Silicon- | Silicon- |
| preventing | based | based | based | based | based | based |
| member | | | | | | |
| UFP | 1.30E+11 | 9.80E+10 | 2.40E+10 | 2.30E+10 | 3.60E+12 | 7.50E+11 |
| generation | | | | | | |
| amount | | | | | | |
| [particles/ | | | | | | |
| 10 min] | | | | | | |

The measurement of the UFP generation amount in each image forming apparatus 10 having a different one of Examples 1-4 and Comparative examples 1 and 2 was performed under the following conditions. Specifically, FMPS (Fast Mobility Particle Sizer) Model 3091 made by TSI Incorporated was used to measure the UFP generation amount. More specifically, each image forming apparatus 10 was laid in a stainless-steel housing with approximate volume 5 m³. The air in the housing was ventilated by a blower and the like at flow velocity 15 m³/h. After a one-hour ventilation, a continuous printing was performed for 10 minutes. Subsequently, the number of UFPs that were generated during the 10 minutes of printing and 50 minutes after the printing (one hour in total) was measured for each image forming apparatus 10 by using the FMPS. The measurement was based on a new Criteria RAL-UZ 171 of the Blue Angel eco-label established by the German Ministry for the Environment, Nature Conservation, and Nuclear Safety (BMU). It is noted that the Criteria RAL-UZ 171 defines the permissible exhaust gas emission rate (Permissible Emission Rate) for office equipment with printing function (printers, copiers, multifunction devices) as 3.5×10¹¹ [particles/10 min].

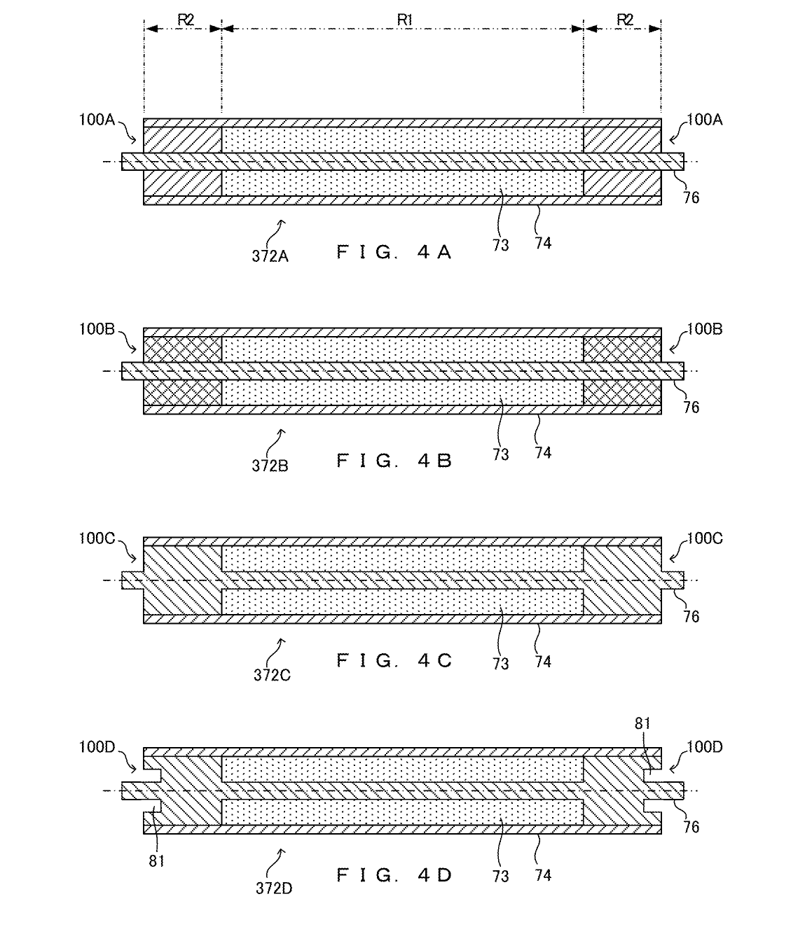

FIG. 4A is a schematic diagram showing the pressure roller 372A. The pressure roller 372A is provided with dust preventing members 100A in the inner layer parts of the pressure roller 372A between the paper non-passing regions R2 and the rotation shaft 76, wherein the dust preventing members 100A are made of fluororesin (PTFE resin). It is noted that the dust preventing members 100A are made of the same material as the fluorine coating layer 74.

FIG. 4B is a schematic diagram showing the pressure roller 372B. The pressure roller 372B is provided with dust preventing members 100B in the inner layer parts of the pressure roller 372B between the paper non-passing regions R2 and the rotation shaft 76, wherein the dust preventing members 100B are made of polyimide-based resin (PAI resin).

FIG. 4C is a schematic diagram showing the pressure roller 372C. A dust preventing member 100C which is provided in the pressure roller 372C is integrally formed with the rotation shaft 76, which is made of aluminum. That is, the dust preventing member 100C is made of aluminum, the same material constituting the rotation shaft 76. The dust preventing member 100C is present in the inner layer parts of the pressure roller 372C under the paper non-passing regions R2. It is noted that the dust preventing member 100C may be integrally formed with the rotation shaft 76, or may be formed as a different member and fitted onto the rotation shaft 76.

FIG. 4D is a schematic diagram showing the pressure roller 372D. A dust preventing member 100D which is provided in the pressure roller 372D is, as in the dust preventing member 100C, integrally formed with the rotation shaft 76 made of aluminum. That is, the dust preventing member 100D is made of aluminum, the same material constituting the rotation shaft 76. In addition, recessed portions 81 are repectively formed on side surfaces of the dust preventing member 100D, the side surfaces being on outer sides in the axis direction of the rotation shaft 76, wherein each recessed portion 81 is deeply hollow in the axis direction. This configuration reduces the weight of the pressure roller 372. It is noted that the dust preventing member 100D may be integrally formed with the rotation shaft 76, or may be formed as a different member and fitted onto the rotation shaft 76. In addition, the dust preventing member 100D may be made of a metal (for example, iron) that is different from the material of the rotation shaft 76.

It is noted that, in each of the pressure rollers 372A to 372D, the elastic member 73 made of silicon rubber is provided between the maximum paper passing region R1 and the rotation shaft 76, and the fluorine coating layer 74 is formed over the whole roller surface of the pressure rollers 372A to 372D.

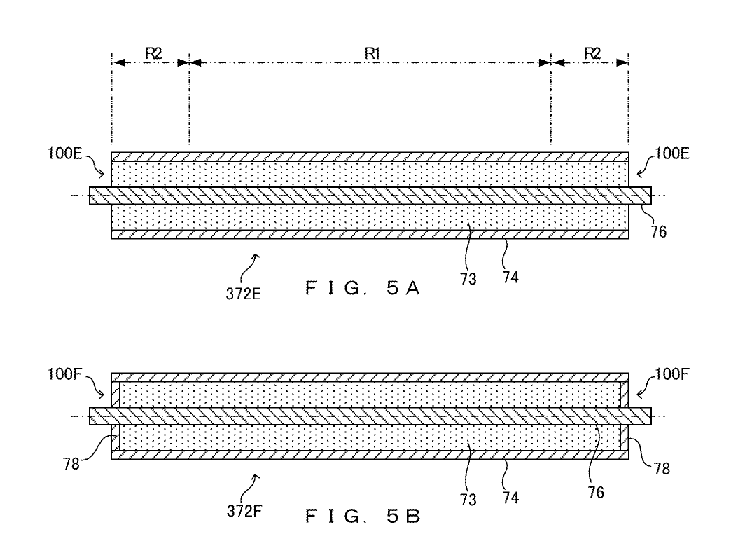

FIG. 5A is a schematic diagram showing the pressure roller 372E. The pressure roller 372E includes, around the rotation shaft 76, the cylindrical elastic member 73 made of silicon rubber, and the fluorine coating layer 74 is formed over the whole roller surface thereof.

FIG. 5B is a schematic diagram showing the pressure roller 372F. The pressure roller 372F includes, around the rotation shaft 76, the cylindrical elastic member 73 made of silicon rubber, and the fluorine coating layer 74 is formed over the whole roller surface thereof. Furthermore, fluorine coating layers 78 are respectively formed on side surfaces of the elastic member 73 that are on opposite sides in the axis direction. It is noted that the thickness of the fluorine coating layers 78 is 1.0 mm, the same thickness as the fluorine coating layer 74.

As will be understood from the experiment results shown in Table 2, an extremely smaller number of UFPs are contained in the exhaust gas of the image forming apparatus 10 of Examples 1 to 4, than in Comparative examples 1 and 2, and the number is lower than the permissible exhaust gas emission rate defined in the Criteria RAL-UZ 171. In the image forming apparatus 10, UFPs are generated also from other members than the fixing device 37. However, in the present embodiment, as described above, the dust preventing members 100 are made of the materials that were specified through the experiment performed on the test pieces. As a result, the amount of UFPs generated from the pressure roller 372 has decreased to such a level as can be evaluated as zero. This is considered to be reflected on the UFP generation amounts of Examples 1 to 4 shown in Table 2.

In the above-described embodiment, the pressure roller 372 is described as an example of the roller member. However, the present invention is not limited to this configuration. For example, when an elastic member made of silicon rubber is included in the heating roller 371, particles of siloxane component may evapolate as UFPs from the silicon rubber when the heating roller 371 is heated by the heater 373 and reaches the predetermined temperature or higher. Thus the dust preventing members 100 may be provided in the heating roller 371.

In the above-described embodiment, the elastic member made of silicon rubber is described as a material that generates UFPs. However, the present invention is applicable to a configuration in which a material that is not silicon rubber but may generate UFPs is used in an elastic member.

The above-described embodiment provides, as an example, a configuration where the rotation shaft 76 and the dust preventing members 100C, 100D are made of aluminum. However, not limited to aluminum, these members may be made of iron, copper, or an alloy containing any of these.

### REFERENCE SIGNS LIST

1 ADF
2 image reading portion
3 image forming portion
4 sheet feed portion
5 control portion
6 display input device
10 image forming apparatus
37 fixing device
73 elastic member
74 fluorine coating layer
76 rotation shaft
100 dust preventing member
371 heating roller
372 pressure roller
373 heater
R1 maximum paper passing region
R2 paper non-passing region

1. A fixing device comprising:
a roller member that is larger in width than a maximum paper passing region through which a sheet of a predetermined maximum size passes;
a heater configured to heat the roller member; and
a dust preventing member provided in an inner layer part of the roller member between a paper non-passing region and a rotation shaft of the roller member, and made of a material from which ultra fine particles are not generated or are difficult to be generated in a temperature environment in which the dust preventing member is heated by heat transmitted from the heater and can reach a predetermined temperature at most, the paper non-passing region being located outside the maximum paper passing region in an axis direction of the rotation shaft.

2. The fixing device according to claim 1, wherein
the dust preventing member is made of fluororesin, polyimide-based resin, or a predetermined metal from any of which a small amount of ultra fine particles are generated in a temperature environment of 230° C. or lower.

3. The fixing device according to claim 2 further comprising
a separation layer portion provided on a surface of the roller member and being a thin layer made of fluororesin that increases a sheet separation performance during fixing, wherein
the dust preventing member is made of a same material, fluororesin, as the separation layer portion.

4. The fixing device according to claim 2, wherein
the rotation shaft is made of the predetermined metal, and
the dust preventing member is integrally formed with the rotation shaft.

5. The fixing device according to claim 4, wherein
a hollow recessed portion is formed on a side surface of the dust preventing member, the side surface being on an outer side in the axis direction of the rotation shaft.

6. The fixing device according to claim 1, wherein
an inner layer part of the roller member between the maximum paper passing region and the rotation shaft is made of silicon rubber.

7. The fixing device according to claim 1, wherein
the roller member is a pressure roller that is provided to be rotatable while being in pressure-contact with a heating roller that is heated by the heater, and is indirectly heated via the heating roller.

8. An image forming apparatus comprising:
the fixing device according to claim 1.
